(19) United States
(12) Patent Application Publication
(10) Pub. No.: US 2015/0010896 A1
(43) Pub. Date: Jan. 8, 2015

(54) STUDY AIDS AND METHODS OF TEACHING A PROCESS TO A STUDENT

(71) Applicant: Dawn MAHAN, Summerland Key, FL (US)

(72) Inventor: Dawn MAHAN, Summerland Key, FL (US)

(21) Appl. No.: 14/325,965

(22) Filed: Jul. 8, 2014

Related U.S. Application Data
(60) Provisional application No. 61/843,580, filed on Jul. 8, 2013.

(51) Int. Cl. G09B 1/30; G09B 5/02; G09B 1/08

(52) U.S. Cl. CPC G09B 1/30; G09B 1/08; G09B 5/02
USPC 434/430

(57) ABSTRACT

It is an object of the invention to provide a study aid including: a blank flowchart including a plurality of states, but omitting text from the plurality of states; and a plurality of tiles bearing a description of each of the plurality of states. It is a further object of the invention to provide a method of teaching a process to a student. The method includes: providing a blank flowchart associated with the process, the blank flowchart including a plurality of states and transitions between the plurality of states, but omitting text from the plurality of states; providing a plurality of tiles bearing a description of each of the plurality of states; and instructing the student to place the tiles over each one of the plurality of states with which each of the descriptions is associated.

### CROSS-REFERENCE TO RELATED APPLICATION

This application claims priority to U.S. Provisional Patent Application Ser. No. 61/843,580, filed Jul. 8, 2013. The entire content of this application is hereby incorporated by reference herein.

### BACKGROUND OF THE INVENTION

A variety of pedagogical approaches exist for studying and teaching a subject to a student. However, many of these approaches rely heavily on rote memorization of materials.

### SUMMARY OF THE INVENTION

It is an object of the invention to provide a study aid including: a blank flowchart including a plurality of states, but omitting text from the plurality of states; and a plurality of tiles bearing a description of each of the plurality of states.

This object of the invention can have a variety of embodiments. The blank flowchart can include transitions between the plurality of states. The blank flowchart can omit transitions between the plurality of states.

The blank flowchart can be applied to a substrate. The substrate can be selected from the group consisting of: paper, cardstock, cardboard, plastic, and rubber. The substrate and the plurality of tiles can both include ferromagnetic materials.

The blank flowchart and the plurality of tiles can be graphical user interface elements implemented by an application stored in computer-readable media. The computer-readable media can further include computer program instructions adapted and configured to assess whether the tiles were accurately associated with the plurality of states. The computer-readable media can further include computer program instructions adapted and configured to allow a user to input a state name into each of the plurality of states.

It is a further object of the invention to provide a method of teaching a process to a student. The method includes: providing a blank flowchart associated with the process, the blank flowchart including a plurality of states and transitions between the plurality of states, but omitting text from the plurality of states; providing a plurality of tiles bearing a description of each of the plurality of states; and instructing the student to place the tiles over each one of the plurality of states with which each of the descriptions is associated.

This object of the invention can have a variety of embodiments. The method can include assessing whether each of the tiles was accurately placed over an associated state.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 depicts a method of teaching a process to a student according to an embodiment of the invention;

FIG. 2 depicts a study aid according to an embodiment of the invention;

FIG. 3 depicts a method of teaching a process to a student according to an embodiment of the invention;

FIG. 4 depicts a set of tiles according to an embodiment of the invention;

FIG. 5 depicts the placement of tiles over blank states on a flowchart according to an embodiment of the invention;

FIG. 6A depicts a blank flowchart including transitions between states according to an embodiment of the invention; and

FIG. 6B depicts a blank flowchart omitting transitions between states according to an embodiment of the invention.

### DEFINITIONS

The instant invention is most clearly understood with reference to the following definitions:

As used herein, the singular form “a,” “an,” and “the” include plural references unless the context clearly dictates otherwise.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

### DETAILED DESCRIPTION OF THE INVENTION

Embodiments of the invention provide study aids and methods of teaching a process to a student. Although, embodiments of the invention may be illustrated herein in the context of preparation for certifications or simply understanding the project management process based on A Guide to the Project Management Body of Knowledge and administered by the Project Management Institute of Newtown Square, Pa., the invention described herein can be applied to any subject.

### Methods of Teaching a Process to a Student

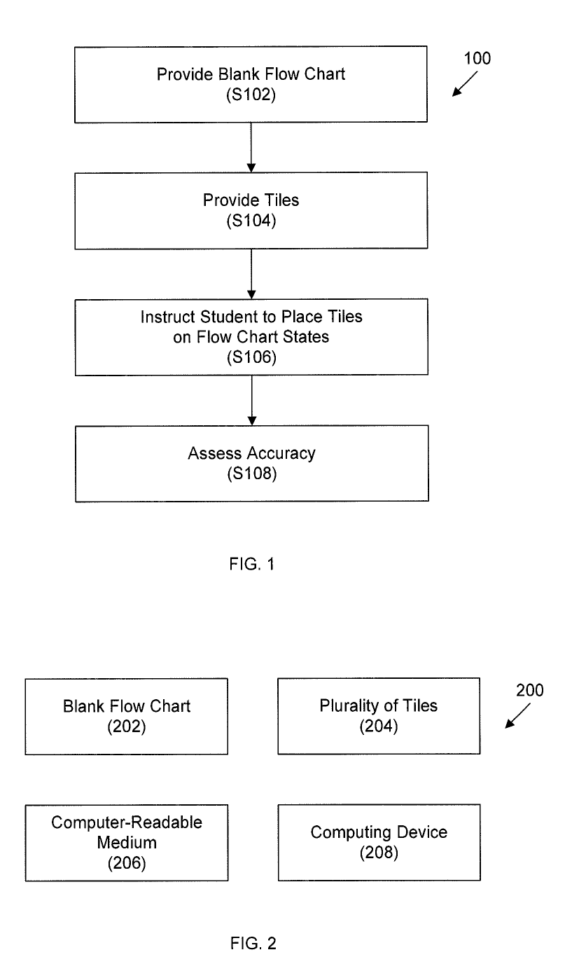

Referring now to FIG. 1, a method 100 of teaching a process to a student is provided.

In step S102, a blank flowchart associated with a process is provided. The blank flowchart includes a plurality of states, but omits text from the plurality of states. The blank flowchart can optionally include transitions between the plurality of states.

In step S104, a plurality of tiles bearing a description of each of the plurality of states is provided.

In step S106, the student is instructed to place the tiles over each one of the plurality of states with which each of the descriptions is associated.

In step S108, whether each of the tiles was placed over an associated state correctly is assessed.

This method can be implemented with or within the study aids and other materials described herein.

### Study Aids

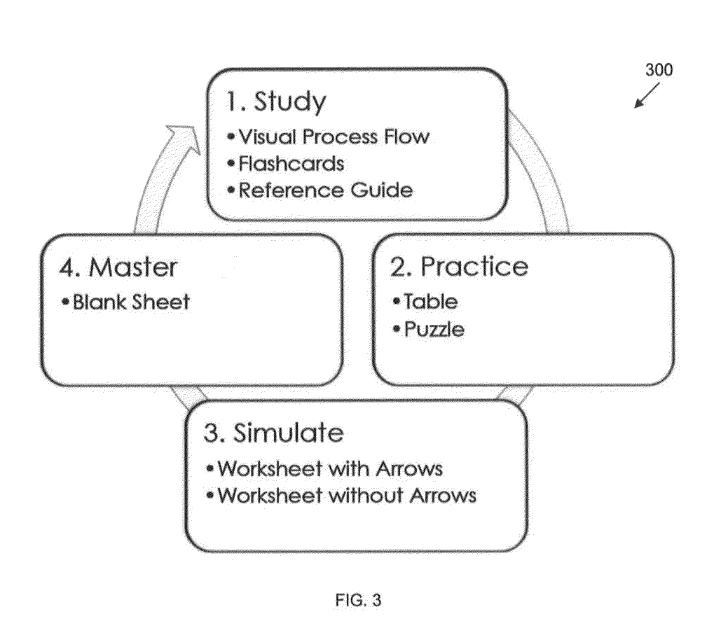

Referring now to FIG. 2, a study aid 200 is provided. The study aid 200 includes a blank flowchart 202 and a plurality of tiles 204. The blank flowchart 202 includes a plurality of states, but omits text from the plurality of states. The plurality of tiles 204 bear a description of each of a plurality of states.

Flowchart 202 and tiles 204 can be implemented as graphical user interface elements that are displayed and manipulated through an application stored in computer-readable medium 206 for execution on a computing device 208 as discussed in greater detail herein.

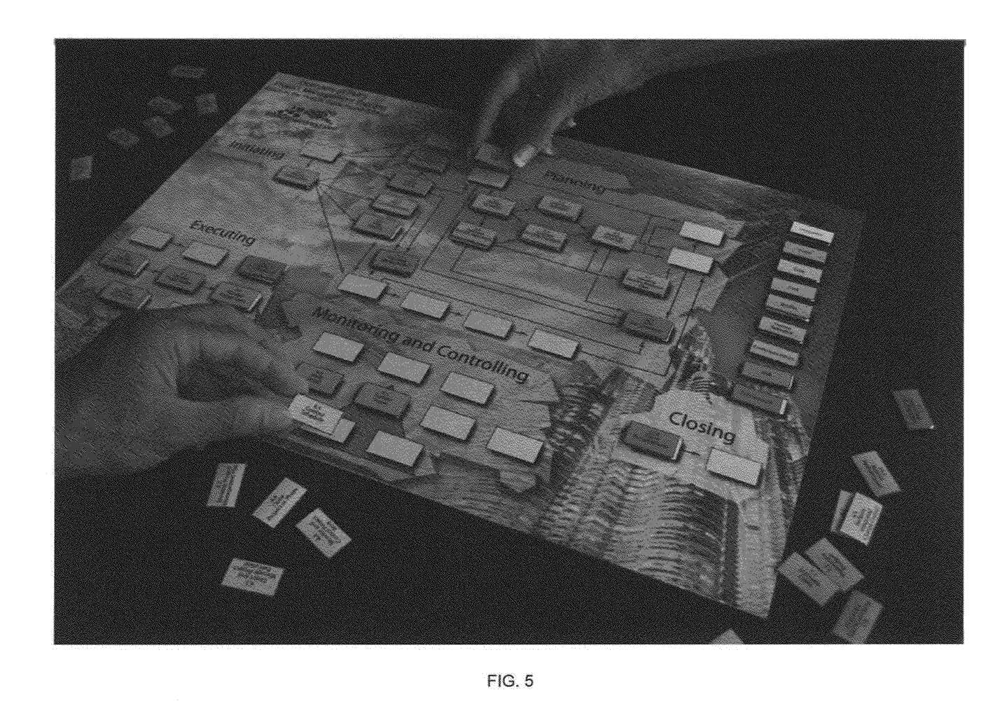

An exemplary set of tiles 204 associated with A Guide to the Project Management Body of Knowledge is depicted in FIG. 4. Tiles 204 can be color coded and can be grouped into various categories in a table.

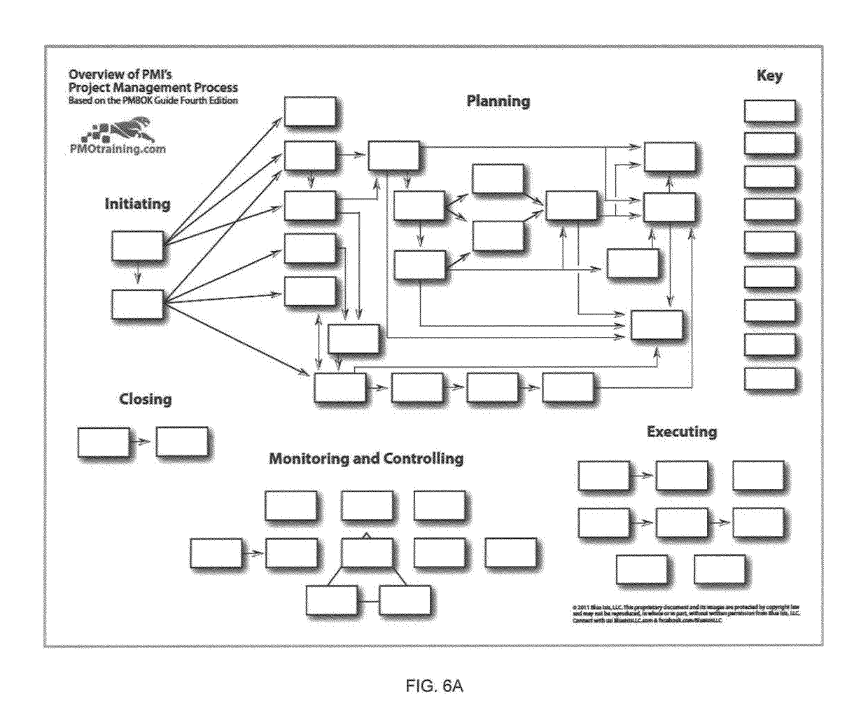

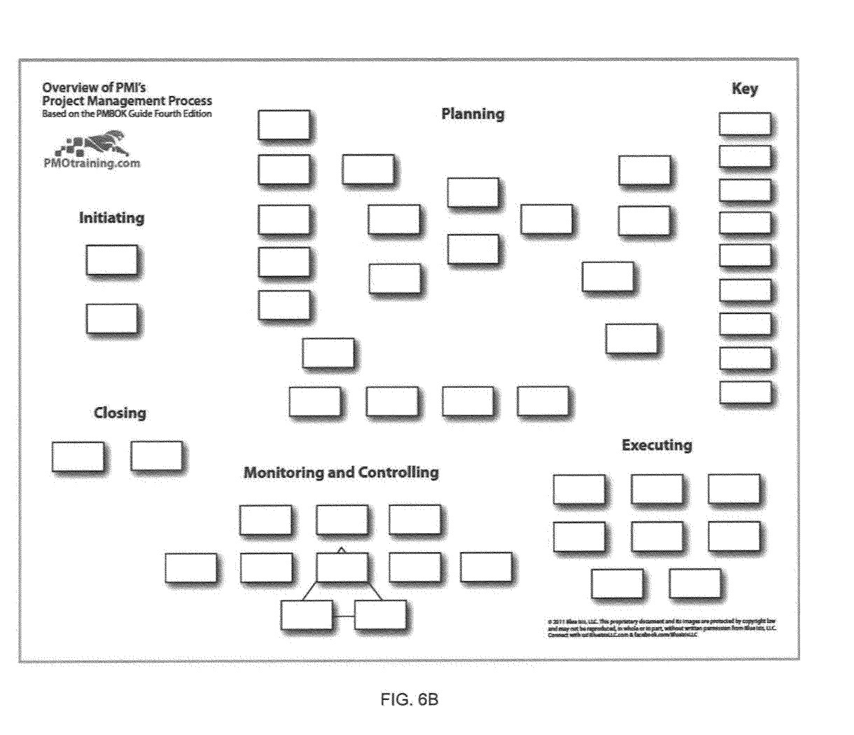

Tile 204 can be moved (e.g., by hand) onto a blank flowchart as depicted in FIGS. 5-6B. In some embodiments, the flowchart includes transitions (e.g., represented by lines or arrows) between states as depicted in FIG. 6A. In other embodiments, all or some transitions are omitted as depicted in FIG. 6B so that the student can learn those transitions.

Incorporation into Overall Teaching/Study Strategy

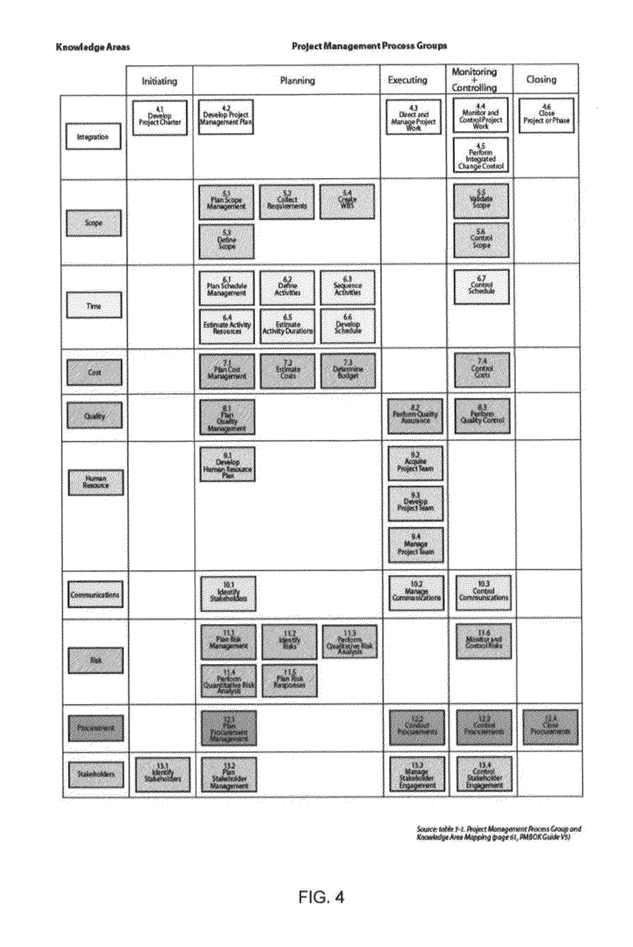

Referring now to FIG. 3, the methods and study aids described herein can be incorporated within a larger method 300 depicted in FIG. 3. First, the student can be instructed to study using a variety of tools such as a completed flowchart illustrating the process to be learned, flashcards describing particular aspects of the process to be learned, and/or a reference guide or other printed or electronic material. Second, the student can be instructed to practice recreating the process by placing tiles representing each state into a table in order to group similar states and then back and forth onto the flowcharts as described herein. Third, the student can be instructed to simulate representation of the process by inserting process information (e.g., through writing or typing) in a blank flowchart as described herein. The flowchart can either include or omit transitions between the states. Fourth, the student can be instructed to draw a flowchart representing the process on a blank sheet of paper.

Such an exercise can be particularly useful for students preparing for an examination that relies on knowledge of the studied process. By utilizing this method, the student can become proficient in the process and can quickly and reliably recreate a flowchart representing the same on paper provided to the student during an examination.

Implementation in Physical and/or Computer-Readable Media

The principles described herein can be implemented in a variety of forms. For example, the flowchart can be applied (e.g., by printing, adhesion, and the like) to a substrate such as paper, cardstock, cardboard, plastic, rubber, magnets, and the like. The tiles can be fabricated from the same or similar materials and techniques.

In another example, one or both of the substrate and plurality of tiles include ferromagnetic materials. For example, the tiles can include a magnet (e.g., a flexible magnet composed of a high-coercivity ferromagnetic compound such as ferric oxide mixed with a plastic binder) and the flowchart can be coupled to a ferromagnetic metal. In another embodiment, the tiles can be magnetic, the flowchart can be printed on a thin material such as paper, and flowchart can be placed on a metal table.

In still another example, the flowchart and the tiles can be implemented as graphical user interface elements that can be manipulated using an application stored in computer-readable media. The computer-readable media can be non-transitory and/or tangible. The application can be executed on a variety of electronic devices including smartphones (e.g., a device sold under the IPHONE® trademark by Apple, Inc. of Cupertino, Calif., the WINDOWS® trademark by Microsoft Corporation of Redmond Wash., the ANDROID™ trademark by Google Inc. of Mountain View, Calif., and the like), a tablet (e.g., devices sold under the IPAD® trademark from Apple Inc. of Cupertino, Calif. and the KINDLE® trademark from Amazon Technologies, LLC of Reno, Nev. and devices that utilize WINDOWS® operating systems available from Microsoft Corporation of Redmond, Wash. or ANDROID® operating systems available from Google Inc. of Mountain View, Calif.), a personal computer, a video game console (e.g., the WII U® console available from Nintendo of America Inc. of Redmond, Wash.; the SONY® PLAYSTATION™ console available from Kabushiki Kaisha Sony Corporation of Tokyo, Japan; the MICROSOFT® XBOX™ console available from Microsoft Corporation of Redmond, Wash.), and the like. For example, a user can use their fingers, a stylus, a mouse, or other user interface tool to drag and drop tiles to the appropriate blank state.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A study aid comprising:
a blank flowchart including a plurality of states, but omitting text from the plurality of states; and
a plurality of tiles bearing a description of each of the plurality of states.

2. The study aid of claim 1, wherein the blank flowchart includes transitions between the plurality of states.

3. The study aid of claim 1, wherein the blank flowchart omits transitions between the plurality of states.

4. The study aid of claim 1, wherein the blank flowchart is applied to a substrate.

5. The study aid of claim 4, wherein the substrate is selected from the group consisting of: paper, cardstock, cardboard, plastic, and rubber.

6. The study aid of claim 4, wherein the substrate and the plurality of tiles both include ferromagnetic materials.

7. The study aid of claim 1, wherein the blank flowchart and the plurality of tiles are graphical user interface elements implemented by an application stored in computer-readable media.

8. The study aid of claim 7, wherein the computer-readable media further includes computer program instructions adapted and configured to assess whether the tiles were accurately associated with the plurality of states.

9. The study aid of claim 7, wherein the computer-readable media further includes computer program instructions adapted and configured to allow a user to input a description into each of the plurality of states.

10. A method of teaching a process to a student, the method comprising:
providing a blank flowchart associated with the process, the blank flowchart including a plurality of states and transitions between the plurality of states, but omitting text from the plurality of states;
providing a plurality of tiles bearing a description of each of the plurality of states; and
instructing the student to place the tiles over each one of the plurality of states with which each of the descriptions is associated.

11. The method of claim 10, further comprising:
assessing whether each of the tiles was accurately placed over an associated state.
